(19) United States
(12) Patent Application Publication
(10) Pub. No.: US 2026/0164526 A1
(43) Pub. Date: Jun. 11, 2026

(54) METHODS, DEVICES AND SYSTEMS FOR LIGHTING SYSTEM CONTROL

(71) Applicant: Gemstone Lights Canada Ltd., Calgary (CA)

(72) Inventors: Dallen Tate Leavitt, Calgary (CA); Justin Hrischuk, Calgary (CA)

(21) Appl. No.: 19/410,953

(22) Filed: Dec. 5, 2025

Related U.S. Application Data
(60) Provisional application No. 63/728,535, filed on Dec. 5, 2024.

(51) Int. Cl. H05B 47/165; H05B 47/155; H05B 47/16; H05B 47/17; H05B 47/175

(52) U.S. Cl. CPC H05B 47/165; H05B 47/155; H05B 47/16; H05B 47/17; H05B 47/1965

(57) ABSTRACT

A method that may be performed by a backend system comprises: receiving subscription data. The subscription data may be received from a frontend device. The method further comprises generating lighting system control data as a function of the subscription data, the lighting system control data comprising, for each of one or more subscribed lighting events, respective event schedule and event lighting pattern information. The method further comprises sending the lighting system control data to a lighting system controller. The subscription data may indicate one or more selected event calendars, each selected event calendar including one or more subscribed lighting events.

### CROSS-REFERENCE TO RELATED APPLICATION(S)

This application is a nonprovisional patent application of and claims the benefit of U.S. Provisional Patent Application No. 63/728,535, filed Dec. 5, 2024 and titled “Methods, Devices and Systems for Lighting System Control,” the disclosure of which is hereby incorporated herein by reference in its entirety.

### FIELD

The present disclosure pertains to an auto event scheduling and calendaring system and more particularly, an auto event scheduling and calendaring system for use with a lighting system such as a light emitting diode (LED) lighting system.

### BACKGROUND

Light Emitting Diode (LED) lighting systems have become ubiquitous as the cost for LEDs have declined. Due to the affordability of these systems, they have become quite popular for use in residential as well as commercial structures. One example LED lighting system includes a series of LEDs encased in plastic “pucks” that are installed in a fitting that may be attached to the eaves or soffit of a house. The fitting can be, for example, an aluminum extrusion having openings in which the “pucks” are fitted. Cabling from a controller to and between the pucks provides power and control signals to the pucks. Another example lighting system includes a series of LEDs mounted to a tape (perhaps self-adhesive tape) that can be mounted under the eaves of a house, stand-alone bulbs, stand-alone or wired spot lights and the like.

As LED costs have declined, the use of increased functionality/color LEDs has increased. Such increased functionality/color LEDS can be, for example, red, green, blue (RGB), RGB white (RGBW) and RGB warm white (RGBWW) LEDs. The increase in LED lighting system functionality and colors, has resulted in increased complexity of controllers for these systems. Some controllers provide users the ability to program certain colors for holidays, festivals, times of the year and such. Nevertheless, these presets are limited. There is a need for improved methods and systems for controlling lighting systems.

### SUMMARY

According to an aspect, there is provided a method comprising: receiving subscription data; generating lighting system control data as a function of the subscription data, the lighting system control data comprising, for each of one or more subscribed lighting events, respective event schedule and event lighting pattern information; and sending the lighting system control data to a lighting system controller.

In some embodiments, the subscription data indicates one or more selected event calendars, each selected event calendar including one or more of the subscribed lighting events.

In some embodiments, the method further comprises updating one of the one or more event calendars. Updated lighting system control data may be generated based on the updated event calendar(s) and sent to the lighting system controller.

In some embodiments, updating the event calendar comprises at least one of: adding a new lighting event to the event calendar; modifying a lighting pattern of at least one lighting event of the event calendar; or modifying a schedule of at least one lighting event of the event calendar.

In some embodiments, the subscription data comprises user-customized configuration data.

In some embodiments, the user-customized configuration data includes event selection data, user-customized schedule data, and/or user-customized lighting pattern data.

In some embodiments, the method further comprises maintaining a database storing data on a plurality of event calendars and subscription data for a plurality of controllers, including the received subscription data.

In some embodiments, the method further comprises, periodically: determining one or more of the subscribed lighting events occurring within a predetermined number of days or predetermined number of events, wherein sending the sending lighting system control data comprises sending the sending lighting system control data corresponding to the lighting events occurring within the predetermined number of days or predetermined number of events.

In some embodiments, generating lighting system control data comprises:
determining that the one or more subscribed events occur during a predetermined time period; generating, for each of one or more lighting system controllers associated with the user, a schedule of subscribed events for the time period; and generating the lighting control data based on the one or more subscribed events for the time period.

In some embodiments, two or more of the subscribed events occur on a same day of the time period, and generating the schedule of subscribed events for the time period comprises selecting one of the two or more of the subscribed events having a highest priority.

In some embodiments, generating the schedule of events further comprises, for at least one of the one or more subscribed events, selecting one of a plurality of light patterns for the subscribed event.

In some embodiments, the plurality of light patterns comprises a default light pattern and a user selected time pattern.

In some embodiments, the predetermined time period comprises n days, wherein n is an integer.

In some embodiments, the subscription data is received at a backend system from a frontend device.

According to another aspect, there is provided a method comprising: receiving, at a front end device, user input indicating a selection of one or more lighting events; generating subscription data as a function of the user input; sending the subscription data to a backend system as a function of the user input, for generation of lighting system control data based on the subscription data, the lighting system control data comprising, for each of one or more subscribed lighting events, respective event schedule and event lighting patter information.

According to another aspect, there is provided a system, such as a backend system, comprising: one or more processors: memory having processor-executable instructions stored therein that, when executed by the one or more processors, implement one or more methods as described herein.

According to another aspect, there is provided a device, such as a frontend device, comprising: one or more processors: memory having processor-executable instructions stored therein that, when executed by the one or more processors, implement one or more methods as described herein.

According to another aspect, there is provided a non-transitory computer-readable medium having stored thereon computer-executable instructions that, when executed, implement or perform one or more of the methods described herein.

Other aspects and features of the present disclosure will become apparent to those ordinarily skilled in the art, upon review of the following description of the specific embodiments of the disclosure.

### BRIEF DESCRIPTION OF THE DRAWINGS

The present disclosure will be better understood having regard to the drawings in which:

FIG. 1 is a functional block diagram of an example system according to some embodiments;

FIG. 2 is a flowchart of an example method according to some embodiments;

FIG. 3 is a flowchart of another example method according to some embodiments;

FIG. 4 is a flowchart of another example method according to some embodiments;

FIG. 5, shows an example “Manage Subscription Events” screen presented by a downloadable app that may be run on a mobile computing device;

FIG. 6 shows an example screen presented by the app that allows a user to select event calendars for subscription;

FIG. 7 shows an example screen presented by the app that allows a user to customize the light pattern for a selected event;

FIG. 8 shows an example screen presented by the app providing setup options for event start and stop times;

FIG. 9 shows an example screen presented by the app providing setup options for selecting types of allowable pattern types;

FIG. 10 illustrates an example screen presented by the app providing options for managing frontend devices that are associated with the user;

FIG. 11 is a functional block diagram of an example backend device according to some embodiments;

FIG. 12 is a functional block diagram of an example frontend device according to some embodiments;

FIG. 13 shows a portion of an exemplary LED lighting string to be installed on a homes soffit;

FIG. 14 shows the portion of the LED lighting string installed on the soffit; and

FIG. 15 is a diagram of another example system 1500 that may implement one or more methods described herein.

### DETAILED DESCRIPTION

While various aspects and embodiments of the disclosure are described herein and shown in the drawings, the present disclosure is to be considered an exemplification and is not intended to limit the claimed subject matter to the specific embodiments illustrated.

Lighting systems, such as exterior LED lighting systems installed on residential or commercial buildings, may comprise a controller coupled to one or more strings of lighting elements (such as LED lights). The controller may be programmable to control the lighting elements to illuminate a variety of lighting patters. A lighting pattern may be defined by one more pattern features including, but not limited to: colors, animation or static lighting, timing, intensity, and the like. Features of lighting animations may include, but are not limited to, moving or unmoving, fade, blinking, timing, count, intensity, etc.

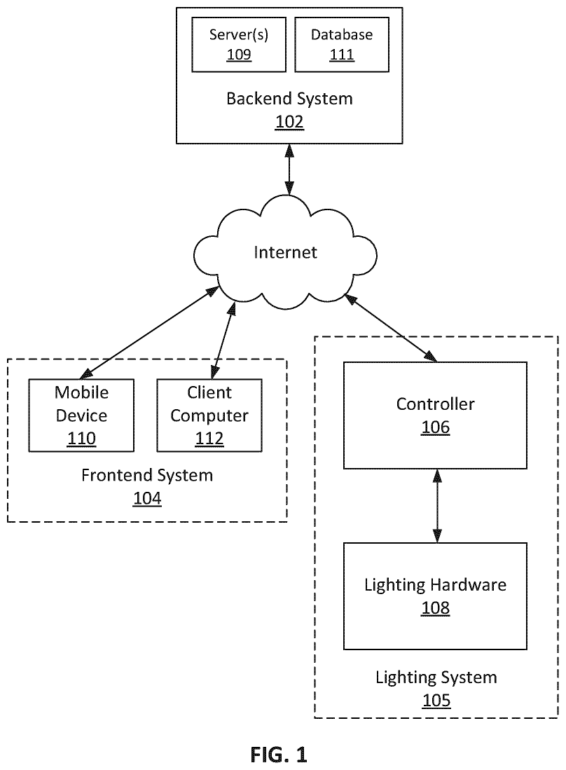

FIG. 1 is a functional block diagram of an example system 100 according to some embodiments. The system 100 includes a backend system 102, a frontend system 104, a lighting system controller 106 and lighting hardware 108. The backend system 102 may be implemented by one or more servers 109, databases 111, and/or other hardware and software running thereon. The backend system 102 may comprise distributed hardware such as a cloud computing system. The frontend system 104 may comprise one or more frontend devices (e.g. client-side), including but not limited to: a mobile computing device 110 such as a smartphone or tablet, or another computing device 112 such as a desktop or laptop computer; etc. The system 100 may include additional components and/or may omit one or more of the components shown in FIG. 1 in other embodiments.

The frontend system 104 may include a downloadable mobile app running on the mobile computing device 110. The frontend system 104 may also include a web interface running on an internet browser of the mobile computing device 110 or other client computing device 112. Embodiments are not limited to these specific examples. The frontend system 104 may simply be referred to herein as “the frontend” 104 and the backend system 102 may simply be referred to herein as “the backend” 102. The backend 102 may maintain a database tracking all calendars, events, patterns, and which devices request them.

The frontend 104 and the controller 106 may communicate with the backend 102 over one or more communication networks such as the Internet. For example, the frontend 104 and the controller 106 may be connected to local networks such as a Wi-Fi network operable for Internet communication. In some embodiments, the frontend 104 may also communicate with the controller 106, for example, via Bluetooth or another communication method. The app may requests control data such as instructions (e.g. the n-day buffer of control data from the backend 102 described below), and then relay it to the controller via Bluetooth. This may provide another communication route in case the controller is not directly connected to the internet.

The lighting system controller 106 may store control data (such as instructions) and execute one or more lighting patterns according to the control data. The lighting hardware 108 may, for example, comprise a one or more LED light strings comprising a series of interconnected LED light modules. In some embodiments, the LED light modules may be in the form of LED “pucks” including red-green-blue-warm white (RGBWW) LEDs that are controllable to illuminate a variety of colors and patterns. The controller 106 may provide power and control signals to the LED light string via a hard wired connection. The controller 106 and the lighting hardware 108 may collectively be referred to as the LED lighting system 105 herein. The lighting system 105 may be installed at a residential building or any other building. Embodiment are not limited to LEDs or lighting strings, and other types of lighting hardware may be used in other embodiments.

According to an aspect of the disclosure, the frontend 104 and backend 102 collectively implement an auto event scheduling and calendaring system (the “auto event system”) and method for automating at least some functionality of the lighting system 105. The auto event system enables a light system controller to automatically receive and display scheduled lighting events configured by the backend 102. The backend 102 may be managed by the provider of the lighting system. The provider may be a manufacturer, seller, or other provider of the lighting system. Alternatively, the provider of the auto event system may be different than the provider of the lighting system.

The frontend 104 may implement one or more user interface elements (e.g. Graphical User Interface (GUI) elements) for receiving user input to select and/or customize options for controlling the lighting system 105. The downloadable application (app) may communicate with the controller 106 and/or the backend 102 to provide illumination scenarios (colors and patterns) for the LEDs in the light string. A user may configure settings through the frontend 104 (e.g. app or web interface). A user may select which event calendars to subscribe to. The user may enable or disable specific events within a given event calendar. The user may, for example, override the lighting system provider's patterns with their own. User-defined patterns and settings may always take priority in some embodiments.

The auto event system may utilize curated calendars and global holidays, to enable users to select specific events and subscribe to the selected events. The auto event system may automate lighting schedules, intensity, and color patterns that may be tailored to user preferences for a seamless and personalized experience. The system may permit as much or as little user interaction as desired. The auto event system may automate aspects of the lighting system 105, using lighting configurations based on selected calendars such as holidays, such as Christmas, regions, or countries such as United States and Canada, and sporting events, such as hockey and football. The auto event system can also allow for adaptive configurations based on user preferences.

For example, for Christmas, prior lighting system controllers may have had a 25-day Advent calendar during Christmas. However, users would be required to set up their own timers for each day for each color and pattern. The auto event system described herein may allow for the selection of pre-programmed colors and patterns by country (e.g., Canada, and the United States), and/or by holiday through GUI elements presented by the frontend 104. As one example, if a subscription for Canadian events is selected, the backend 102 may send control data to the controller 106 to implement holidays or special light scenarios related to Canada throughout the year. Sending the control data may comprise indirectly sending the control data to the controller 106, such as via one or more networked components or devices intermediate the backend system and the controller 106. The calendar events may be managed by the backend 102, including adding, modifying or removing events or lighting patterns associated therewith. Updated control data with the updated events and/or lighting patterns may automatically be sent to the controller, in accordance with the subscription or customization options selected by a user.

The provider of the auto event system may create and manage multiple event calendars. The event calendars may change year to year. Examples of event calendars include but are not limited to regional holidays, sporting events and religious holidays. Each event calendar may contain event schedules (e.g. days or date ranges), and each event may have one or more patterns created or selected by the provider. A pattern may comprise an animation which describes how the lights operate along with other parameters (ex: colors, brightness, speed), Each event may have one or more multiple default patterns for variety. Users may override the automatically assigned pattern by choosing from the pattern patterns or a different pattern altogether.

Event calendars to which a user may subscribe may be based on various categories, including but not limited to: countries, movies, holidays (e.g. religious or secular holidays), cultural celebrations, etc. Each event calendar may include one or more lighting events (schedule, pattern(s)) according to the given category.

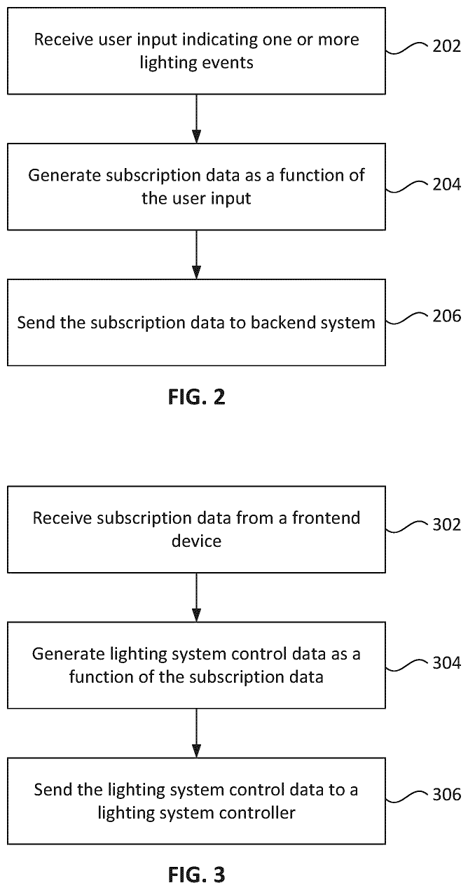

FIG. 2 is a flowchart of an example method 200 according to some embodiments. The method 200 may be performed by a frontend device for controlling the lighting system 105 of FIG. 1. The method 200 may be implemented may an app running on the frontend device.

At block 202, the frontend device 104 receives user input indicating a selection of one or more lighting events. The user input may, for example, indicate a selection of one or more subscribed event calendars. The frontend device may present GUI elements allowing a user to select from a plurality of event calendars. The calendars may be based on one or more categories such as geographical region(s), holidays, religions, etc. The user input may also indicate individual subscribed lighting events and/or customization options. Customization options may include customized schedule and/or lighting pattern data. The customization data may indicate changes or modifications relative to default schedules and lighting patters associated with the event calendars. The user input may, for example, comprise selection of one or more buttons, sliders, fields, or other user interface elements presented on the GUI.

At block 204, subscription data is generated as a function of the user input. The subscription data may indicate light event subscription(s) such as event calendar subscription(s) and/or possibly customization data including custom options selected by the user. The subscription data may indicate one or more selected event calendars, each selected event calendar including one or more of the subscribed lighting events. The subscription data may comprise user-customized configuration data. The user-customized configuration data may comprise one or more of: event selection data, user-customized schedule data, and/or user-customized lighting pattern data

At block 206, the subscription data is sent to the backend 102 for generation of lighting system control data based on the subscription data. The lighting system control data comprise, for each of one or more subscribed lighting events, respective event schedule and event lighting patter information.

In some embodiments, the frontend 102 sends the lighting system control data to the controller 106 (e.g. over the internet). In other embodiments, the frontend 102 may send the lighting system control data to a client device (e.g. mobile computing device) of the frontend 104 which, in turn, forwards the lighting system control data to the controller 106 (e.g. via Bluetooth).

FIG. 3 is a flowchart of an example method 300 according to some embodiments. The method 300 may be performed by the backend 102 for controlling the lighting system 105 of FIG. 1. For example, the method may be performed by the server(s) 109 of FIG. 1.

At block 302, the backend 102 receives subscription data from a frontend device (of the frontend 104), such as the mobile device 110 or other client computing device 112.

At block 304 lighting system control data is generated as a function of the subscription data. The lighting system control data comprise, for each of one or more subscribed lighting events, respective event schedule and event lighting pattern information. The lighting pattern information may define, for a given event, pattern color(s), animation(s), intensity, timing etc. for illumination of LED lights of the lighting system 105.

At block 306 the lighting system control data are sent from the backend 102 to the lighting system controller 106 of the lighting system 105.

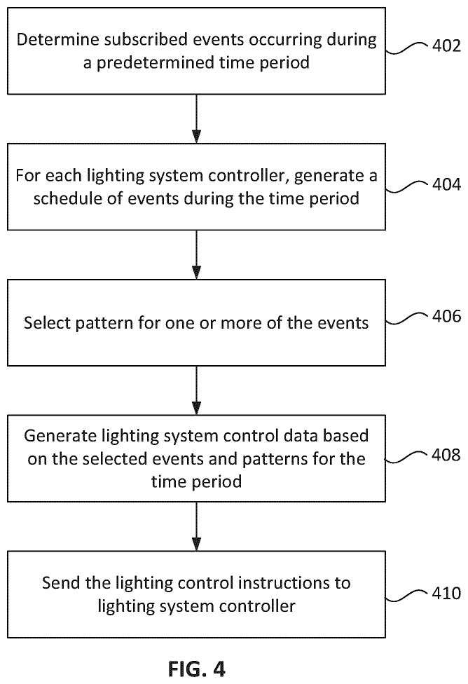

FIG. 4 is a flowchart of another method 400 that may be performed by the backend 102. For example, the method 400 may be performed by the server 109. One or more steps of the methods 300 and 400 of FIGS. 3 and 4 may be combined in some embodiments. The method 400 is described below with respect to a single controller and group of one or more frontend devices associated therewith. The group of one or more frontend devices in this context may refer to a user “homegroup”, account, or other system by which multiple user devices operated by the same user may be associated with the same light system controller. However, the backend 102 may perform this or other methods for all users, devices, and/or light system controllers associated with to the backend.

At block 402, the backend 102 checks one or more databases (e.g. database 111) containing information on event calendars, events and subscription data received from one or more frontend devices associated with one or more lighting system controllers (e.g. controller 106 of FIG. 1). The backend 102 checks the database(s) and determines events occurring during a predetermined time period, such as a number of upcoming days and subscribed to by the user. Each user or account may be associated with a respective one or more light system controllers, such as the controller 106 of FIG. 1.

At block 404, the backend 102 generates a schedule of events during the time period. For example, the time period may be the next upcoming seven days, and the backend 102 may determine events scheduled for each of the seven days. If a subscription includes multiple events overlapping on the same day, the backend 102 may select the event with the highest priority for that day. For example, events may be assigned priority levels based on various criteria including, but not limited to: event calendar type; event type; user selection; and/or other factors. As one example, an event specifically and individually subscribed to by a user using the front end may be assigned a higher priority than an event within a subscribed event calendar for the year.

Optionally, at block 406, the backend 102 selects a default pattern or a user-selected pattern, where applicable, for one or more of the events. If a user has not selected a particular pattern for a given event, the default pattern may be selected. However, if a user has customized a pattern or selected a pattern other than the default for a given event, then that pattern may be selected.

At block 408, the backend generates lighting control data based on the subscribed events and patterns for the time period (i.e. the selected event and pattern for each day in the period having an event). The control data may comprise instructions for implementing the patterns and schedules of the events for the time period.

At block 410 the lighting system control data are sent to the controller 106 for controlling the lighting system 105. The backend 102 may send the control data to the controller 106 over the Internet. Alternatively, the control data may be sent to a frontend device, which then forwards the control data to the controller 106. Any suitable method to communicate lighting system control data may be used.

The backend 102 may send only the next n-days (e.g. seven days) of data as an n-day rolling buffer, where n is an integer. The buffer may also be based on a number of events rather than days. The backend may send the next n-events (or up to a maximum number of events). In some embodiments, the backend 102 may periodically prepare and send lighting control data, such as at a predefined interval (e.g. every 24 hours). For each interval, the backend 102 may calculates the next n days of events (or n events) and sends them to each controller 106 of each device subscribed to the system. The controller 106 may receive control data automatically but may request specific data if needed. The controller 106 may acknowledge receipt back to the backend 102. If a user changes a pattern, subscribes to a calendar, or enables/disables an event, the backend 102 may resend the n-day buffer. This rolling n-day buffer update keeps the lighting system 105 functional even if the controller or frontend goes offline.

Generating and sending lighting system control data covering a period of multiple days, in the rolling buffer method described herein, may have the benefit that a temporary network outage may not prevent the controller from having lighting control data for that day. The buffer may also be based on a predetermined number of events rather than a predetermined number of days or other time period. The number of days (or number of events) included in each transmission of control data may be selected based a least in part based on memory resources of the controller. For example, sending seven days worth of control data rather than one month or one year's worth of control data may reduce controller memory requirements.

The backend 102 may maintain the database(s) of calendars, events, patterns, and subscriber information. From time to time, event calendars may be added, modified or removed. Updating the event calendar comprises at least one of: adding a new lighting event to the event calendar; modifying a lighting pattern of at least one lighting event of the event calendar; modifying a schedule of at least one lighting event of the event calendar. Individual events may also be added, modified, or removed. Patterns associated with the events may also be added, modified, or removed. The lighting system control data generated and sent to the controller 106 according to the methods 300 and/or 400 of FIGS. 3 and 4 may, thus, take into account such updates.

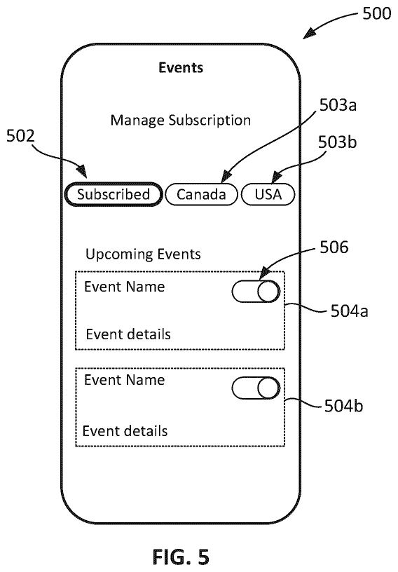

FIGS. 5 to 10 illustrate examples of screens with GUI elements presented by a downloadable app that may be run on a mobile computing device 110 (e.g. smartphone) of the frontend system 104. The app may provide multiple screens that a user may navigate between, with each screen including respective GUI elements for controlling one or more aspects of the lighting system 105. The screens may allow for selecting and/or customizing subscriptions to event calendars, individual events, etc. Embodiments are not limited to the specific examples of FIGS. 5 to 10.

Referring now to FIG. 5, there is shown an example “Manage Subscription Events” page or screen 500 according to some embodiments. This screen 500 may allow for managing subscriptions to all subscribed events (by selecting button 502), or events of selected event calendars (e.g., such as subscriptions to specific countries by selecting button 503a or 503b), etc. This may allow allows for customizing of illuminating certain patterns for those events. Events of a selected category (e.g. by selecting button 502, 503a, 503b, or more) may be indicated, with a GUI area (e.g. areas 504a and 504b) for each event. The area for each event may show an event name, event details (e.g. selected pattern) and on/off toggle 506 that allows the user to subscribe or unsubscribe to the particular event. Controls for modifying patterns, schedules, or navigating to other screens with such functionality may be provided.

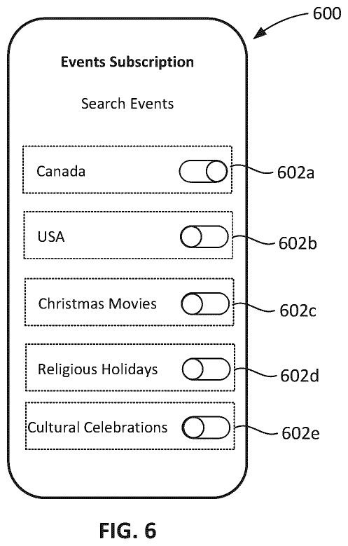

FIG. 6 illustrates an example screen 600 presented by the app that allows a user to select event calendars for subscription. The screen shows example event calendars 602a to 602e titled “Canada”, “USA”, “Christmas Movies”, “Religious Holidays”, “Cultural Celebrations”, each having an on/off toggle to allow the user to subscribe (or not) to the corresponding event calendar.

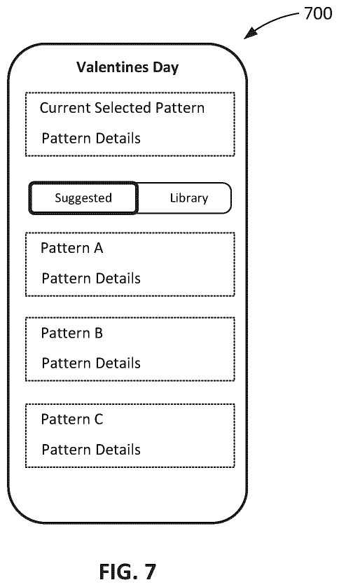

FIG. 7 illustrates an example screen 700 that allows a user to customize the light pattern for a selected event. In this example, the selected event is a Valentine's Day event. The page 700 may indicate a default or currently selected pattern, and optionally one or more additional patterns available for selection (shown in FIG. 7 as Pattern A, Pattern B, etc.). The additional patterns may be part of a suggested set of patterns, or a library of patterns created or downloaded by the user. In the event settings of the auto event system, other patterns may be suggested and the user may be able to simply tap on one to select that suggested pattern. If the user decides to select their own pattern, the user can tap on (see FIG. 6) and they can select their preferred pattern.

In one example, a user may select an event titled “Holiday Twinkle” (which may be set for an event on December 1^{st}, for example). and the user may be provided with a list of suggested patterns from which the user can choose or, if desired, the user can select their library (see FIG. 7) and choose a specific pattern for that day. Tf the user doesn't want to do anything for a particular date, such as December 2, but they were still subscribed to an event calendar having an event that day, they can toggle off the event for that day. Likewise, for Christmas, for example, a “Christmas Movies” event calendar may provide lighting scenarios (patterns and schedules) for 25 days based on Christmas movies. That event calendar may include events scheduled from December 1st to December 25th.

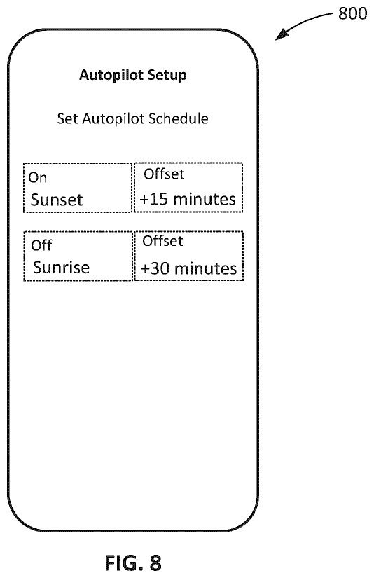

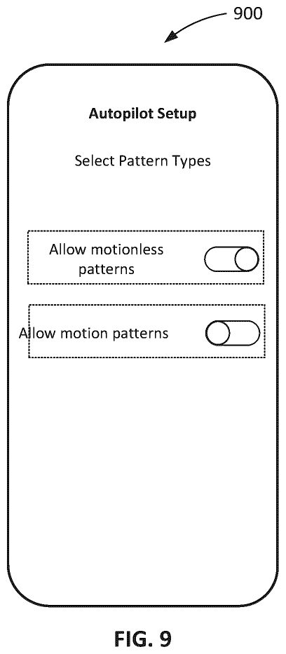

FIG. 8 illustrates an example screen 800 providing setup options for indicating when events should start and stop (relative to sunset and sundown in this example). FIG. 9 illustrates an example screen 900 providing setup options for selecting types of allowable pattern types. This specific example allows for selection of allowing motionless and/or motion patterns. Activation of the system, and the selection of preferences may made through simply toggling events on and off through the user screens. Users may also select whether to use animated patterns, motionless patterns, or both, and can adjust on and off times, unsubscribe from categories, and choose which devices the auto event system controls.

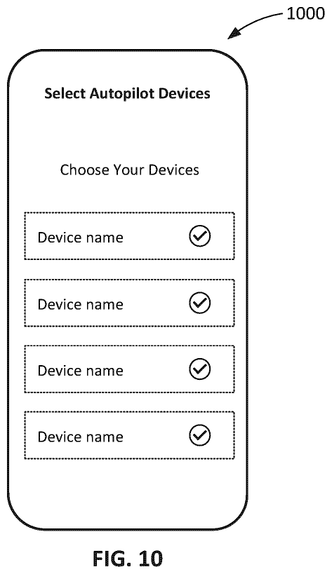

FIG. 10 illustrates an example screen 900 providing options for managing frontend devices that are associated with the user (e.g. a user account). Each of the devices associated with the user may be setup to control the lighting system 105 via the backend 102.

Set up of the auto event system may also be simple and straight forward through the app. Upon downloading and selecting a control to initiate setup, the app may provide one or more setup screens, such as but not limited to the examples in FIGS. 6, 8 and/or 9. Embodiments are not limited to the particular screens shown in FIGS. 6 to 10 and one or more additional screens with GUI elements for controlling the system may be provided.

It will be appreciated that the auto event system enables users to operate lighting systems event schedules through an auto scheduling system that has preprogrammed lighting scenarios. The system may provide automation of lighting systems with minimal user intervention, and personalized lighting configurations based on selected calendars such as Christmas holiday scenarios, US holidays, Canadian holidays, sporting events and the like. Further, the system provides adaptive configurations based on user preferences.

Calendars may be provided, enabling users to subscribe to specific events such as Christmas, US holidays, Canadian holidays, sporting events and more. A list of global holidays may be provided and categorized for convenience, possibly allowing users to select and display their preferred holidays on their lights. User customization may allow optional customization of automation settings, including motion or motionless patterns, timing preferences, and/or the selection of patterns.

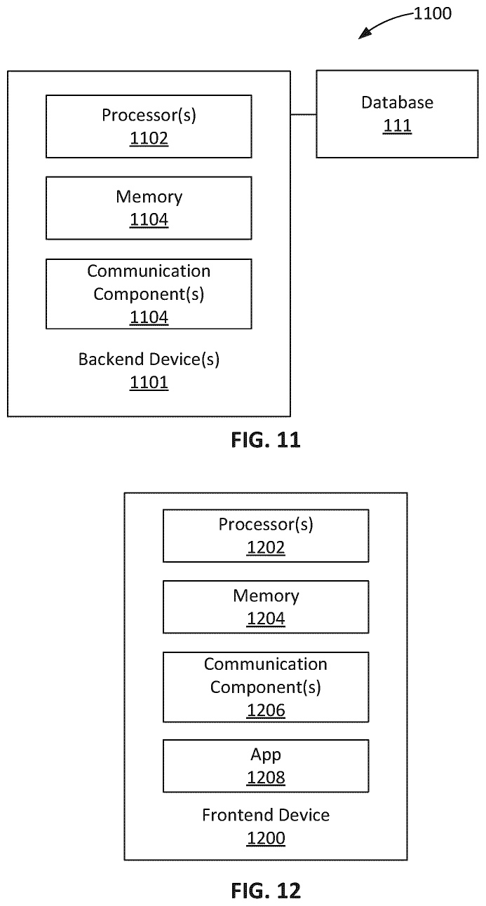

FIG. 11 is a functional block diagram of an example backend system 1100 according to some embodiments. The system 1100 includes one or more backend devices 1101, which may be in the form of one or more servers, for example (such as the server(s) 109 in FIG. 1). The system 1100 may be configured to perform one or more of the methods described herein. The backend device(s) 1101 are shown operatively coupled to a database 111 (e.g. via a network connection). The database 111 may be internal to the device(s) 1101 in other embodiments. The device(s) 1101 may comprise one or more processors 1102 and memory 1104. The memory 1104 may have processor-executable instructions stored thereon that, when executed, cause the device(s) 1101 to implement one or more of the backend methods described herein, such as the method 300 and/or 400 of FIGS. 3 and 4.

The device(s) 1101 may further comprise one or more communication components 1106. The communication components 1106 may include components for communicating with one or more other computer systems, network components, or other devices over one or more communication networks. For example, the communication components 1106 may facilitate communication with the external database 111. The communication component(s) 1106 may include, but are not limited to, at least one transmitter and at least one receiver (collectively referred to as at least one transceiver), at least one antenna, a network interface controller (NIC). The various components of the device(s) 1101 may be implemented as one or more circuits (such as one or more electronic circuits and/or one or more optical circuits).

The system 1100 may be implemented by various combinations of computer hardware and software. In some embodiments, the backend system 1100 may include distributed hardware and/or may be implemented using a service, such as Amazon Web Services™ (AWS).

FIG. 12 is a functional block diagram of an example frontend device 1200 according to some embodiments. The mobile computing device 110 in FIG. 1 may be in the form of the device 1200 or may include the device 1200. The device 1200 may be configured to perform one or more of the frontend methods described herein. The device 1200 may comprise one or more processors 1202 and memory 1204. The memory 1204 may have processor-executable instructions stored thereon that, when executed, cause the controller to implement one or more of the frontend methods described herein, such as the method 200 of FIG. 2. The processor-executable instructions may run as app 1208 or in a web-based interface. Any suitable combination of hardware (e.g. circuitry) and/or software may be used.

The device 1200 may further comprise one or more communication components 1206. The communication components 1206 may include components for communicating with one or more other computer systems, network components, or other devices over one or more communication networks. For example, the communication components 1206 may facilitate communication with the backend 102 and/or the controller 106. The communication component(s) 1206 may include, but are not limited to, at least one transmitter and at least one receiver (collectively referred to as at least one transceiver), at least one antenna, a network interface controller (NIC). The various components of the device 1200 may be implemented as one or more circuits (such as one or more electronic circuits and/or one or more optical circuits). The device 1200 may be implemented by various combinations of computer hardware.

The system 1100 and device 1200 of FIGS. 11 and 12 may also comprise other components such as interface component(s) configured for interaction with a user or other devices. Each interface component may comprise any suitable structure for providing information to or receiving information from a user and may be, for example, a speaker, a microphone, a keypad, a keyboard, a display, a touch screen, and/or the like.

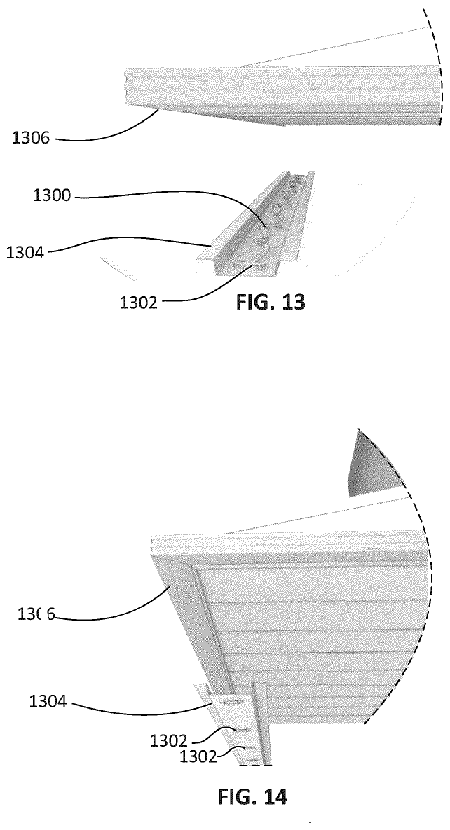

FIGS. 13 and 14 show a portion of an exemplary LED lighting string 1300 including interconnected LED modules 1302 (including plastic pucks with LED lights housed therein) installed in a section of track 1304. FIG. 14 shows the track 1304 positioned for installation on a home's soffit 1306.

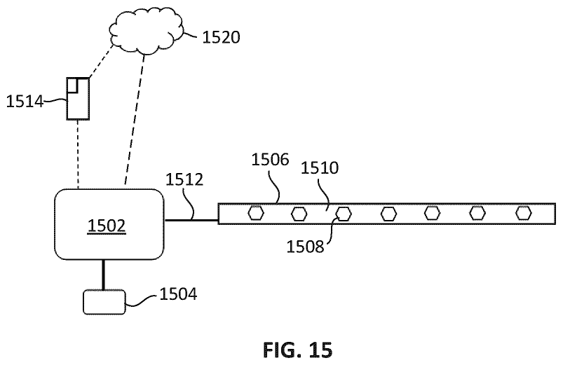

FIG. 15 is a diagram of another exemplary LED lighting system 1500 that may implement one or more methods described herein. The system 1500 include a controller 1502, a power source 1504, and a light assembly 1506. The light assembly 1506 includes a series of light elements 1508 that can be installed in a track 1510 or other physical structure. In one configuration, the series of light elements 1508 are connected to one another and to the controller 1502 by a power and communication cable(s) 1512.

The system 1500 further includes an app running on a frontend device 1514, such as a downloadable app. The downloadable app may allow creation of custom patters, selection of subscription details for automatically scheduling lighting patters, etc. The controller 1502 and frontend device 1514 may communicate with the backend (not shown in FIG. 15) through one or more networks, such as the Internet 1520. In some embodiments, the controller may communicate directly with the frontend device 1514 via a connection, such as a Bluetooth connection.

It is to be understood that a combination of more than one of the approaches described above may be implemented. Embodiments are not limited to any particular one or more of the approaches, methods or systems or devices disclosed herein. One skilled in the art will appreciate that variations, alterations of the embodiments described herein may be made in various implementations without departing from the scope of the claims.

1. A method comprising:
receiving subscription data;
generating lighting system control data as a function of the subscription data, the lighting system control data comprising, for each of one or more subscribed lighting events, respective event schedule and event lighting pattern information; and
sending the lighting system control data to a lighting system controller.

2. The method of claim 1, wherein the subscription data indicates one or more selected event calendars, each selected event calendar including one or more of the subscribed lighting events.

3. The method of claim 2, further comprising updating one of the one or more event calendars.

4. The method of claim 3, wherein updating the event calendar comprises at least one of:
adding a new lighting event to the event calendar;
modifying a lighting pattern of at least one lighting event of the event calendar; or
modifying a schedule of at least one lighting event of the event calendar.

5. The method of claim 1, wherein the subscription data comprises user-customized configuration data.

6. The method of claim 5, wherein the user-customized configuration data includes event selection data, user-customized schedule data, and/or user-customized lighting pattern data.

7. The method claim 1, further comprising maintaining a database storing data on a plurality of event calendars and subscription data for a plurality of controllers, including the received subscription data.

8. The method of claim 1, further comprising, periodically:
determining one or more of the subscribed lighting events occurring within a predetermined number of days or a predetermined number of events, wherein sending the sending lighting system control data comprises sending the sending lighting system control data corresponding to the lighting events occurring within the predetermined number of days or the predetermined number of events.

9. The method of claim 1, wherein generating lighting system control data comprises:
determining that the one or more subscribed events occur during a predetermined time period;
generating, for each of one or more lighting system controllers associated with the user, a schedule of subscribed events for the time period; and
generating the lighting control data based on the one or more subscribed events for the time period.

10. The method of claim 9, wherein two or more of the subscribed events occur on a same day of the time period, and generating the schedule of subscribed events for the time period comprises selecting one of the two or more of the subscribed events having a highest priority.

11. The method of claim 9, wherein generating the schedule of events further comprises, for at least one of the one or more subscribed events, selecting one of a plurality of light patterns for the subscribed event.

12. The method of claim 11, wherein the plurality of light patterns comprises a default light pattern and a user selected time pattern.

13. The method of claim 9, wherein the predetermined time period comprises n days, wherein n is an integer.

14. The method of claim 1, wherein the subscription data is received at a backend system from a frontend device.

15. A method comprising:
receiving, at a front end device, user input indicating a selection of one or more lighting events;
generating subscription data as a function of the user input;
sending the subscription data to a backend system as a function of the user input, for generation of lighting system control data based on the subscription data, the lighting system control data comprising, for each of one or more subscribed lighting events, respective event schedule and event lighting patter information.

16. A system comprising:
one or more processors:
memory having processor-executable instructions stored therein that, when executed by the one or more processors, implement a method comprising:
receiving subscription data;
generating lighting system control data as a function of the subscription data, the lighting system control data comprising, for each of one or more subscribed lighting events, respective event schedule and event lighting pattern information; and
sending the lighting system control data to a lighting system controller.

17. The system of claim 16, wherein the subscription data indicates one or more selected event calendars, each selected event calendar including one or more of the subscribed lighting events.

18. The system of claim 17, further comprising:
updating one of the one or more event calendars.

19. The system of claim 17, wherein the subscription data is received at a backend system from a frontend device.

20. A device comprising:
one or more processors:
memory having processor-executable instructions stored therein that, when executed by the one or more processors, implement a method comprising:
receiving, at a front end device, user input indicating a selection of one or more lighting events;
generating subscription data as a function of the user input;
sending the subscription data to a backend system as a function of the user input, for generation of lighting system control data based on the subscription data, the lighting system control data comprising, for each of one or more subscribed lighting events, respective event schedule and event lighting patter information.
